(19) United States
(12) Patent Application Publication
(10) Pub. No.: US 2009/0245213 A1
(43) Pub. Date: Oct. 1, 2009

(54) Efficient Quality of Service (QoS) Scheduling in OFDMA Wireless Networks

(75) Inventors: Ahmed N. Zaki, Calgary (CA); Abraham Fapojuwo, Calgary (CA)

Correspondence Address: FULBRIGHT & JAWORSKI L.L.P., 600 CONGRESS AVE., SUITE 2400, AUSTIN, TX, 78701, US

(73) Assignee: UTI LIMITED PARTNERSHIP, Calgary (CA)

(21) Appl. No.: 12/412,351

(22) Filed: Mar. 26, 2009

Related U.S. Application Data
(60) Provisional application No. 61/039,575, filed on Mar. 26, 2008.

(51) Int. Cl. H04W 72/04; H04J 3/00; H04L 27/28

(52) U.S. Cl. 370/336; 375/260

(57) ABSTRACT

A system and methods for A method for efficient Quality of Service (QoS) scheduling in OFDMA wireless networks are presented. In one embodiment, the method includes determining a number of time slots to allocate to one of a plurality of wireless mobile stations according to a linear solution that satisfies one or more data access requirements and maximizes base station utilization. The method may also include adjusting the linear solution in response to a determination that a power consumption value exceeds a predetermined threshold value. Additionally, the method may include granting the one or more mobile stations access to the time slots in accordance with the linear solution.

### CROSS-REFERENCE TO RELATED APPLICATIONS

This application claims priority to U.S. Provisional Application No. 61/039,575 filed Mar. 26, 2008. The entire text of the above-referenced disclosure is specifically incorporated herein by reference without disclaimer.

### BACKGROUND OF THE INVENTION

1. Field of the Invention

This application relates to an Orthogonal Frequency Division Multiple Access (OFDMA) technology applied to wireless communication networks, and more particularly, to radio resource management and scheduling in such networks.

2. Description of Related Art

OFDMA is one of the main multiple access candidate scheme for Broadband 3G/4G systems. In part due to its efficient fast fading mitigation inherited from the Orthogonal Frequency Division Multiplexing (OFDM). In OFDMA, the total available bandwidth is subdivided to many subchannels, so that more than one user can transmit or receive simultaneously. Thus, using OFDMA leads to higher system utilization and capacity, because the users' traffic can be sent on the subchannels on which the signal to noise ratio (SNR) is relatively higher. Although the term user and mobile station may be used interchangeably in the present description, a user actually refers to the person using the mobile station. Thus, the user requirements, user inputs, user constraints, and the like are actually manifest as requirements, inputs and constraints of the mobile station.

Considering the downlink (DL) direction, from the base station to the mobile station, the resources available to the base station are mainly power and OFDMA subchannels. Scheduling involves the problem of how to assign the proper OFDMA subchannel and modulation/coding method to each user, in a multi-user system, in such a way that maximizes the system's throughput and, at the same time, satisfies all users' Quality of Service (QoS) requirements and other system constraints. The scheduling algorithm must take into account several factors that impact the overall performance of the system. These factors include user-specific parameters such as the instantaneous quality of each subchannel experienced by the user, the QoS requirements, the instantaneous traffic requirements, and other global parameters, like the number of active users from each service class in the system.

Due to its complexity, the scheduling problem in OFDMA networks has received considerable attention in the literature over the past few years. The general approach taken is to analytically formulate the scheduler as a mathematical programming problem, and then develop efficient algorithms to solve the proposed problem. Efficient algorithms must achieve the best performance results, while maintaining low-complexity under reasonable and practical traffic loads. Efficient scheduling algorithms are crucial in the design of any base station in an OFDMA-based network. The scheduling algorithm effectively determines the QoS experienced by the individual users and the total system capacity which directly affects the provider's revenue.

The following is a summary of the major used notations:

| | |
|---|---|
| K: | Total number of subchannels. |
| N: | Number of users with non-empty DL queues in the system. |
| Rₙ: | Number of bits required by the n^{th} real-time (RT) user (constant |
| | in every frame). |
| D: | Set of allowed number of bits per OFDM symbol. It is assumed |
| | that all MSs have the same modulation/coding capabilities and |
| | thus, any user can send or receive with any number of bits/symbol |
| | from the set D. |
| M: | The number of bits/symbol in the set D that the transmitter and |
| | receiver can use. This number is the cardinality (number of |
| | elements) of the set D. |
| C_{k,n}: | A generic cost incurred for allocating one time slot of the |
| | k^{th} subchannel to the n^{th} user. For example, C_{k,n} can |
| | be interpreted as the number of data bits assigned to the n^{th} user |
| | on the k^{th} subchannel (C is any element in D). |
| T: | The number of time slots in the DL subframe. |
| P_{T}: | Total DL power constraint on the base station. |

The referenced shortcomings are not intended to be exhaustive, but rather are among many that tend to impair the effectiveness of previously known techniques in OFDMA scheduling; however, those mentioned here are sufficient to demonstrate that the methodologies appearing in the art have not been satisfactory and that a significant need exists for the techniques described and claimed in this disclosure.

### SUMMARY OF THE INVENTION

From the foregoing discussion, it should be apparent that a need exists for a system and methods for efficient quality of service (QoS) scheduling in OFDMA wireless networks.

A method for efficient QoS scheduling is presented. In one embodiment, the method includes determining a number of time slots to allocate to one of a plurality of wireless mobile stations according to a linear solution that satisfies one or more data access requirements and maximizes base station utilization. The method may also include adjusting the linear solution in response to a determination that a power consumption value exceeds a predetermined threshold value. Additionally, the method may include granting the one or more mobile stations access to the time slots in accordance with the linear solution.

In a further embodiment, the determining a number of time slots may include generating a generalized Minimum Cost Network Flow (MCNF) model of a scheduling problem, and determining a solution to the generalized MCNF model. Additionally, the method may include dropping a mobile station in response to a determination that the solution to the generalized MCNF model is not feasible.

In still another embodiment, the method may include determining a dual simplex solution to the generalized MCNF model according to a dual simplex process in response to a determination that the solution to the generalized MCNF model results in a power consumption level that is greater than a predetermined power consumption threshold. The method may also include dropping a mobile station in response to a determination that the dual simplex solution to the generalized MCNF model is not feasible.

In certain embodiments, the method includes approximating the linear solution according to a rounded integer solution. In another embodiment, the method may include maintaining a token bucket for each of a plurality of non-real-time mobile stations and determining whether to allocate a time slot to one or more of the plurality of non-real-time mobile stations in accordance with a size of the token bucket associated with the mobile station.

In a further embodiment, determining the number of time slots to allocate further includes dividing the time slots into a first zone and a second zone. In such an embodiment, determining the number of time slots to allocate may also include generating a respective generalized Minimum Cost Network Flow (MCNF) model of a scheduling problem for each of the first zone and the second zone according to a zone type associated with the first zone and the second zone. Further, determining the number of time slots to allocate may also include calculating a linear solution that satisfies one or more data access requirements and maximizes base station utilization for each zone respectively.

In one embodiment, the method may also include determining a number of time slots to allocate to one of a plurality of communication mobile stations, each mobile station having one or more antennas according to a linear solution that satisfied one or more data access requirements and maximizes base station utilization This embodiment may include adjusting the linear solution, for each of the one or more antennas respectively, in response to a determination that a power consumption value exceeds a predetermined threshold value for the respective antenna. This embodiment, may also include granting the one or more antennas associated with the mobile stations access to the time slots in accordance with the linear solution.

A multi-carrier wireless communication system is also presented. In one embodiment, the system includes one or more wireless mobile stations and a base station . The wireless mobile stations may communicate information according to one or more predetermined communication configurations. The base station may determine a number of time slots to allocate to one of the mobile stations according to a linear solution that satisfies one or more data access requirements and maximizes base station utilization. The base station may also adjust the linear solution in response to a determination that a power consumption value exceeds a predetermined threshold value. Additionally, the base station may grant the one or more mobile stations access to the time slots in accordance with the linear solution.

A computer readable medium comprising computer readable instructions that, when executed by a computer, such as a computer associated with a base station, cause the computer to the perform certain operations is also presented. In one embodiment, the operations include determining a number of time slots to allocate to one of a plurality of wireless mobile stations according to a linear solution that satisfies one or more data access requirements and maximizes base station utilization. The operations may also include adjusting the linear solution in response to a determination that a power consumption value exceeds a predetermined threshold value. Additionally, the operations may include granting the one or more mobile stations access to the time slots in accordance with the linear solution.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a logical diagram illustrating one embodiment of a frame structure in an OFDMA system;

FIG. 2 is a schematic block diagram illustrating one embodiment of a system for efficient QoS scheduling in an OFDMA wireless network;

FIG. 3 is a logical block diagram illustrating one embodiment of a multi-layer data communications model;

FIG. 4 is a schematic flowchart diagram illustrating one embodiment of a method for efficient QoS scheduling in an OFDMA wireless network;

FIG. 5 is a detailed schematic flowchart diagram illustrating a further embodiment of a method for efficient QoS scheduling in an OFDMA wireless network;

FIG. 6 is a logical diagram illustrating one embodiment of a generalized Minimum Cost Network Flow (MCNF) model;

FIG. 7 is a logical diagram illustrating another embodiment of a generalized MCNF model;

FIG. 8 is a logical diagram illustrating one embodiment of a token bucket queuing arrangement;

FIGS. 11A and 11B illustrate graphical representations of average data rate per non-real-time user from simulation tests;

FIG. 12 illustrates a graphical representation of the probability of scheduler failure from simulation tests;

FIG. 13 illustrates a graphical representation of system utilization from simulation tests; and

FIGS. 14A and 14B illustrate graphical representations of the cumulative distribution function for data rate per non-real-time user from simulation.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

### System Model

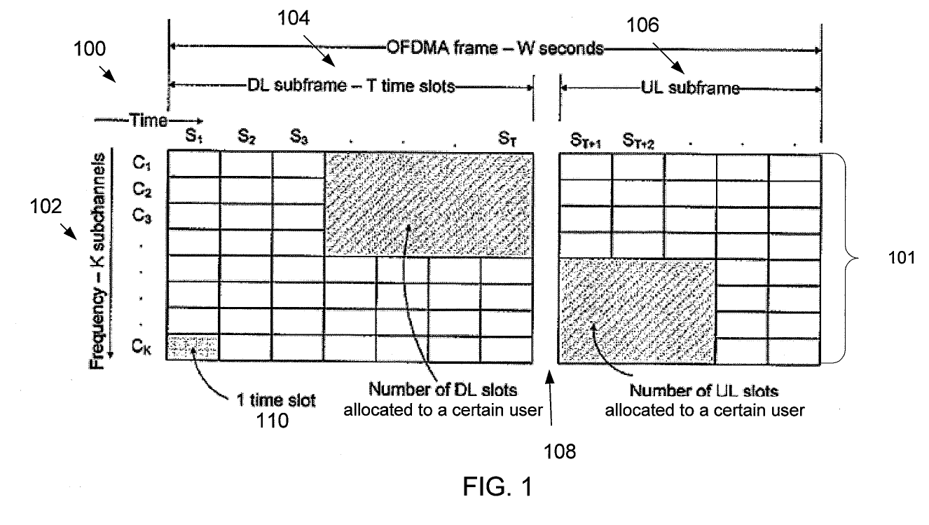

The frame structure 100 of OFDMA systems is shown in FIG. 1. The total bandwidth 101 is divided into K subchannels 102, each containing the same number of OFDM data subcarriers (not shown). Due to frequency selective fading, each user may have a different SNR for the different subcarriers. The DL Channel State Information (CSI) (not shown) is either sent by the MS or can be estimated by the base station in Time Division Duplex (TDD) systems due to channel reciprocity with the uplink (UL). Thus, complete CSI of all subchannels 102 for all users is assumed to be available at the base station. As the number of OFDM subcarriers is generally very large (e.g., standards for WiMAX networks defined by the IEEE 802.16e Task Group defines 512, 1024 or 2048 subcarriers), and due to the scarcity of bandwidth, the MS sends the subchannels' CSI to the base station at the end of every frame 100. Also, the base station allocates the system's bandwidth to different users on a per subchannel 102 basis. Hence, channel allocation in the present embodiments is based upon subchannels 102 and not on subcarriers.

The system is operating in TDD mode with the frame 100 divided into a DL subframe 104 and an UL subframe 106 each with variable number of OFDM symbols. The boundary 108 can be changed from frame to frame depending on the DL and UL loads. We assume that there are T available time slots 110 in the current DL subframe 104. A time slot 110 is defined as one OFDM symbol in one subchannel 102. For each time slot 110, all subcarriers within the same subchannel 102 are assigned to the same user using the same modulation/coding scheme. Thus, bandwidth resources available to the base station can be viewed as the total number of available time slots 110. For now, only the DL direction is studied with the assumption that the number of time slots 110 allocated for the DL is fixed.

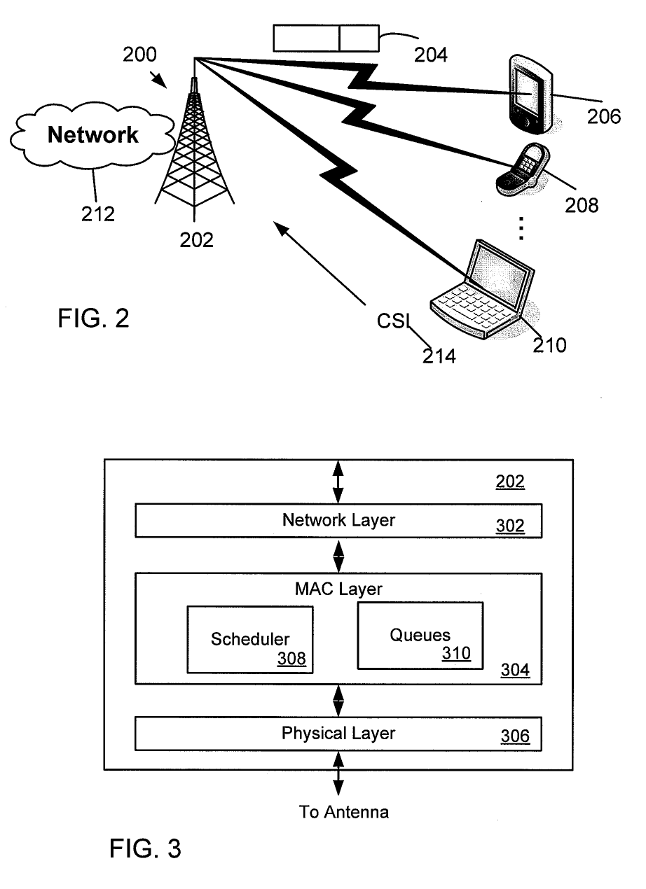

With reference to FIGS. 2 and 3, the present embodiments may be useful within a wireless communication networks such as system 200 in which a base station 202 simultaneously transmits respective data 204 addressed to a plurality of mobile stations (e.g. 206, 208 and 210). Typically, in the downlink direction, the base station has knowledge of the queue state information (not shown) of incoming signals (e.g. via network 212) and CSI of mobile stations 206, 208, 210 (e.g. CSI 214 of mobile station 210) and allocates base station resources for each of the incoming and outgoing signals. As noted previously, considering the DL direction in the OFDMA framework, the resources available to the base station 202 are mainly power and OFDMA subchannels 102. Scheduling is the problem of assigning the proper OFDMA subchannel 102 and modulation/coding method to each mobile station 206, 208, 210 in a multi-mobile station 206, 208, 210 system 200 in such a way that maximizes the system's throughput and at the same time satisfies all mobile stations' 206, 208, 210 QoS requirements and other system constraints. Scheduling operations may include consideration of several factors that impact the overall performance. These factors may include, for example, mobile station 206, 208, 210-specific parameters such as the instantaneous quality of each subchannel 102 experienced by the mobile station 206, 208, 210, the QoS requirements, the instantaneous traffic requirements, and other global parameters like the number of active mobile stations 206, 208, 210 from each service class in the system.

Traffic for a particular mobile station 206, 208, 210 may be considered to fall within one of two broad service classes or types: real-time services (e.g. VOIP services) and non-real time services (e.g. HTTP or FTP services). In one embodiment of the method 400, real-time (RT) services are allocated a constant number of bits every frame 100. On the other hand, the traffic of each non-real-time (NRT) mobile station 206, 208, 210 may be shaped as described below. In one embodiment, NRT traffic may be shaped using a token bucket algorithm. The number of bits that are allocated to each NRT mobile station 206, 208, 210 depend on many parameters including the current size of the mobile station's 206, 208, 210 token bucket and the mobile station's 206, 208, 210 QoS parameters. Primarily, a token bucket may be employed for each NRT mobile station 206, 208, 210 to allow the scheduler to temporarily postpone the transmission of some NRT data to be able to transmit other RT or urgent NRT data. In other words, the proposed scheduler supports a time domain degree of freedom. Though a token bucket control on traffic is presented herein, other control mechanisms may be employed as will be apparent to persons of ordinary skill in the art.

FIG. 3 is a simplified block diagram showing portions of base station 202. In the DL direction, scheduling at a base station 202 is typically performed by a scheduler unit 308 that is a functional element of a MAC layer 304 for transmitting data from mobile station 206, 208, 210 queues (collectively 310). Scheduling is performed for traffic received via a network layer 302 for transmission through a physical layer 306 to a radio antenna (not shown).

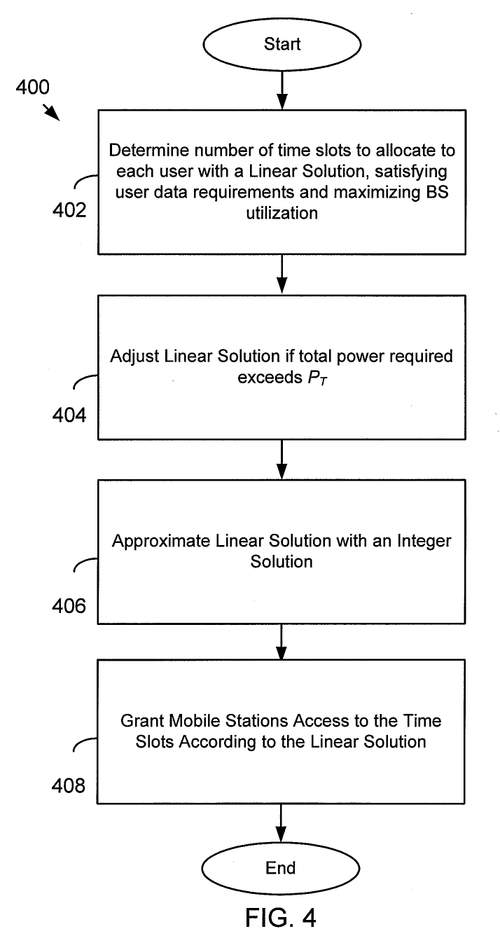

While shown as implemented with the MAC layer 304, scheduler 308 may be implemented in two or more layers (e.g. MAC layer 304 and physical layer 306 or a higher layer). It is understood that the embodiments described herein may be implemented in software and/or computing hardware base station 202 may comprise any computing device such as a computer having a controller. The controller may be coupled to one or more storage devices (e.g. RAM and/or ROM) storing instructions for configuring the controller to perform the algorithmic solution described herein including those operations in accordance with an embodiment described with respect to FIG. 4.

FIG. 4 illustrates one embodiment of a method 400 for efficient QoS scheduling in an OFDMA wireless network. In particular, the method 400 may include determining a solution to solve the scheduling problem. The method may include determining 402 a number of time slots 110 to allocate to one of a plurality of wireless mobile stations according to a linear solution that satisfies one or more data access requirements and maximizes base station utilization. The method 400 may also include adjusting 404 the linear solution in response to a determination that a power consumption value exceeds a predetermined threshold value. Additionally, the method 400 may include granting 408 the one or more mobile stations access to the time slots 110 in accordance with the linear solution. In a further embodiment, the method 400 may additionally include approximating 406 the linear solution according to a rounded integer solution.

If the scheduler cannot reach a solution that satisfies all the constraints, the problem may be considered infeasible. Under this condition, several alternatives may be considered to arrive at a feasible solution. One alternative includes relaxing the QoS requirements of the mobile stations 206, 208, 210. Another alternative may include to reducing the number of mobile stations 206, 208, 210 generating traffic, for example, the mobile station 206, 208, 210 with the lowest signal to noise ratio in a frame may be dropped from the scheduling problem.

In one embodiment, β denotes the number of bits that can be transmitted in one time slot 110 on any subchannel 102 using BPSK (i.e. one bit per subcarrier), referred to as a data unit. In the present embodiments, it is assumed that the n^{th} RT mobile station 206, 208, 210 requires Rₙ bits every frame. Hence, the number of data units required by the n^{th} RT mobile station 206, 208, 210 in each frame equals to |Rₙ/β|, where |x| is the smallest integer larger than or equal x. To support time diversity at the MAC layer, the scheduling algorithm may not restrict the number of bits that should be transmitted to any NRT mobile station 206, 208, 210 to a fixed number. Additionally, it may be assumed that the number of data units that may be transmitted to the n^{th} NRT mobile station 206, 208, 210 is be bounded by a lower bound Lₙ and upper bound Uₙ. For example, a simple approach to determine these bounds using a token bucket may include methods described in Zaki, Ahmed, et al., “A Novel Radio Resource Management Approach for QoS Provisioning in Multi-service Multi-slot OFDMA Systems,” Accepted for Presentation at IEEE WCNC Conference (April 2008), which is incorporated herein by reference in its entirety. However, other methods may be used to provide time diversity so long as it provides the bounds {Lₙ, Uₙ}.

In one embodiment, scheduling solutions for OFDMA networks may be include Linear Programming (LP) and graph theories. However, the transmission power needed to transmit one time slot 110 is a nonlinear function of the modulation and coding type and also the coding rate. Thus, LP alone, is may not be sufficient to solve the scheduling problem. Logical subchannel 102s may resolve this issue. A logical subchannel 102 is associated with a physical subchannel that may only be used with one modulation/coding combination from D. Hence, the total number of logical subchannel 102s G=KM. In other words, the physical subchannel may be duplicated for each available modulation type/coding rate in the set D. In one embodiment, only the predetermined modulation type and coding rate may be used on the designated logical subchannel 102. The number of data units transmitted on a logical subchannel 102 S_{g} in one time slot 110 may be a constant integer that equals dₘ/β, where dₘ is the corresponding element in D. Therefore, since it can be assumed that the base station only uses the best coding type supported by the respective mobile station, the power needed to transmit to a certain mobile station 206, 208, 210 on a certain logical subchannel 102 may be a linear function of the number of time slots 110 allocated to that mobile station 206, 208, 210 on that subchannel 102.

The transmission power required to send a single slot to the n^{th} mobile station 206, 208, 210 on the g^{th} logical subchannel 102 may be described as P_{g,n} and may be calculated by (in dB units):

P_{g,n}=SNRreq−ChannelGain+ThermalNoise (1)

where SNRreq is the required signal to noise ratio which is a function of the modulation/coding used and the number of subcarriers per subchannel 102. The ChannelGain may be due to path loss, fast fading and large scale fading. In one embodiment, the fast fading component is the same for all logical subchannel 102s belonging to the same physical subchannel. In one embodiment, the base station 202 may update P_{g,n} for all mobile stations 206, 208, 210 and logical subchannel 102s before solving the scheduling problem.

Finally, the solution to the scheduling problem may include a two-dimensional integer vector X where X_{g,n} equals the number of time slots 110 allocated to the n^{th} mobile station 206, 208, 210 on the g^{th} logical subchannel 102. In a certain embodiment, the number of variables in X equals: KMN=GN.

One embodiment of a mathematical representation of the optimal scheduling problem may be described as:

$$\begin{matrix}\begin{matrix}{arg max}_{{X}_{g , n}} {\sum }_{n = 1}^{N} {\sum }_{g = 1}^{G} {C}_{g , n} {X}_{g , n} & \end{matrix} & & & \\ s . t . & & & \\ \begin{matrix}{\sum }_{g = 1}^{G} {S}_{g} {X}_{g , n} = ⌈ {R}_{n} / B ⌉ & ∀ n ∈ \{ RT users \}\end{matrix} & ( 2 a ) & & \\ \begin{matrix}{U}_{n} \geq {\sum }_{g = 1}^{G} {S}_{g} {X}_{g , n} \geq {L}_{n} & ∀ n ∈ \{ NRT users \}\end{matrix} & ( 2 b ) & & \\ \begin{matrix}{\sum }_{n = 1}^{N} {\sum }_{g ∈ k} {X}_{g , n} \leq T & ∀ k ∈ \{ 1 , 2 , … K \}\end{matrix} & ( 2 c ) & & \\ {\sum }_{n = 1}^{N} {\sum }_{g = 1}^{G} {P}_{g , n} {X}_{g , n} \leq {TP}_{T} & ( 2 d ) & & \\ {X}_{g , n} ∈ {Z}^{+} ∀ g , n & ( 2 e ) & & \end{matrix}$$

In Eq. (2), the system's utility denoted by CX may be maximized. In this embodiment, the mathematical representation Eq. (2) includes certain constraints (2a-2e). The first constraint (2a) may ensures that the RT mobile stations 206, 208, 210 are allocated their required fixed data rates. The second constraint (2b) may specify that the number of data units that should be sent to an NRT mobile station 206, 208, 210 is bounded by the lower limit Lₙ and the upper limit Uₙ. Constraints (2a) and (2b) may guarantee fairness between different mobile stations 206, 208, 210 in the system. The third constraint (2c) may limit the total number of time slots 110 allocated to all mobile stations 206, 208, 210 on logical subchannel 102s belonging to the same physical subchannel to a predetermined threshold value T. As the average maximum power allowed for each OFDM symbol may be represented as P_{T}, the fourth constraint (2d) may limit the total transmitted power for the whole DL sub-frame to TP_{T}. The last constraint (2e) may ensure that the solution vector X of the problem assume integral values from the positive integer space Z⁺.

In one embodiment, the system's throughput under the LP problem defined by the constraints (2a)-(2d) may be maximized according to the method 400. This may ensure that NRT traffic that was postponed in previous frames will be transmitted as soon as possible. However, if the cost function is defined simply as SX, the scheduling problem may be degenerate (i.e., have more than one optimal solution). To illustrate further, consider the simple example of one mobile station 206, one modulation/coding scheme, and two subchannel 102s. If C_{g,n}=S_{g}, then the optimal solution may include sending the data on any subchannel 102 as both have the same value of S_{g}. However, the total power resulting from transmitting on a different subchannel 102s may not be the same. In one embodiment, it may be preferable to transmit only on the subchannel 102 with the lowest power P_{g,n}. Thus, the utility vector may be described as C:C_{g,n}=S_{g}−γP_{g,n}, where γ is an arbitrary small constant. In such an embodiment, the slope of the objective hyperplane may be changed so that the optimal solution would be the same as solving to maximize SX, but require the least possible total power. For example, γ may be selected such that the change in the slope of the objective hyperplane in each direction is less than the minimum difference in the gain (in terms of data units) from transmitting one time slot 110 on any two logical subchannel 102s, i.e., max{γP_{g,n}}<min{Sₖ−Sₗ:k,l ε 1,2, . . . G}. Since P_{g,n}<P_{T}, the following relationship may exist γ=min{Sₖ−Sₗ}/P_{T}.

### Example Embodiments of the Method

The scheduling problem represented in Eq. (2) may represent an Integer Programming (IP) problem that has a complicated combinatorial nature. Finding an optimal integral solution to such a problem may require prohibitively complex IP methods. Alternatively, a standard sub-optimal way to solve the problem is to drop the integrality constraint defined by Eq. (2e) and solve the relaxed linear problem Eqs. (2a)-(2d). To get a near-optimal integer solution to the scheduling problem defined by Eq. (2), the optimal solution of the relaxed linear problem may be approximated.

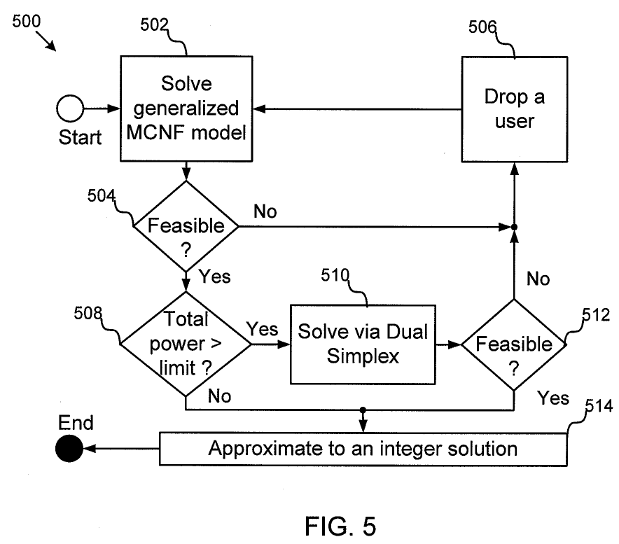

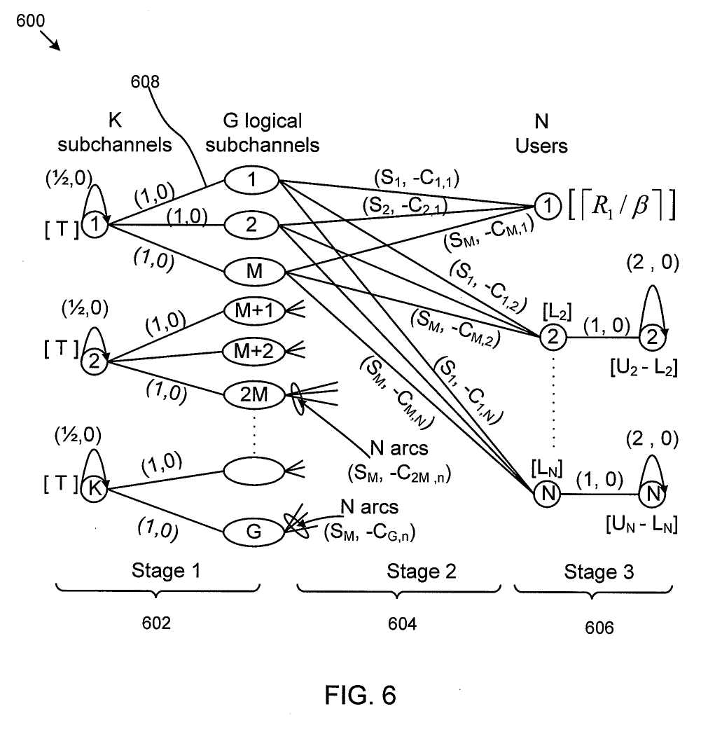

For example, the flowchart depicted in FIG. 5 describes one embodiment of a method 500 for scheduling that may solve (2a)-(2d). First, the scheduling problem subject to (2a)-(2c) may be modeled as illustrated in FIG. 6, 7, or 10 and solved 502 using a generalized Minimum Cost Network Flow (MCNF) model. If a determination 504 is made that the problem is infeasible, then one of the mobile stations 206, 208, 210 may be dropped 506 (requirements associated with the dropped mobile station 206, 208, 210 may be ignored only for the current frame). It may be assumed that the mobile station 206, 208, 210 with the worst average SNR is dropped 506 from the scheduling problem. Alternatively, other criteria may be used to determine which mobile station 206, 208, 210 to drop 506.

Second, if a solution is found but it is determined 508 that the total power for the solution exceeds a predetermined limit TP_{T} (2d), the method may include solving 510 a dual simplex function to find an optimal solution to a relaxed problem (2a)-(2d). If it is determined 512 that the problem is still infeasible, then one of the mobile stations 206, 208, 210 may be dropped 506. Finally, a simple rounding method may be used to approximate 514 the optimal linear solution with an integer solution.

FIG. 6 illustrates one embodiment of a generalized MCNF model that may solves (2a)-(2c) according to an optimal solution. In FIG. 6, nodes have either a supply or demand (shown in brackets) and an arc 608 that is associated with a (gain, cost) for a pair of nodes. In a first stage 602, each subchannel 102 may be modeled by a supply node with T time slots 110 available. Each self-arc on these nodes may be lossy in order to consume any unused time slots 110. Thus, the gain may be set to 0.5 (it can be set to any number less than 1). In a further embodiment, each logical subchannel 102 (single modulation/coding scheme per physical subchannel) may be modeled as a unique node with zero supply. All arcs 608 connecting the physical subchannel nodes to logical subchannels' 102 nodes have a gain equal to 1 (since a time slot 110 is transferred unchanged).

The second stage 604 may model and solve the scheduling problem as represented in Eq. (2) without certain simplifying assumptions. For example, in stage 2 604, arcs 608 may be used to connect the logical subchannels' 102 nodes to the mobile stations' 206, 208, 210 nodes. Each arc 608 may represent a gain of Sₘ=dₘ/β. This gain may model the ability of the modulation type and coding rate to convert one time slot 110 to Sₘ data units (i.e., Sₘβ bits). Thus, the flow on the network may be converted from time slots 110 to data units. On the other hand, the cost on each arc may be set to −C_{g,n}. Therefore, as the network model minimizes the total cost, the solution also maximizes the number of data units delivered to the mobile station 206, 208, 210 nodes with the least possible total power. Since the arcs 608 connecting the logical subchannel 102s with the mobile stations' 206, 208, 210 nodes may the only arcs representing the variables in Eq. (2), the cost on all other arcs may be set to zero.

An RT mobile station 206, 208, 210 may be modeled by one node with demand |Rₙ/β| as described above. For example, according to Eq. (2) each NRT may have two inequalities. Thus, each NRT mobile station 206, 208, 210 may be modeled by two nodes. The first node may be directly connected to all logical subchannel 102 nodes and its demand may be substantially equivalent to the lower bound Lₙ. The second node's demand may be substantially equivalent to the difference between the upper and lower requirements of the NRT mobile station 206, 208, 210 (i.e., Uₙ−Lₙ). Thus, in total, the two nodes may require Uₙ data units. However, if an optimal solution is found, the arcs connecting the logical subchannel 102s nodes to the mobile station 206, 208, 210 nodes may carry a number of data units bounded by [Lₙ,Uₙ]. The self-arcs on the second nodes may ensure the feasibility of the MCNF model by generating a deficit flow between the solution and maximum requirement Uₙ (note that the self-arc may have a gain of 2, or another value larger than one).

The solution to the scheduling problem may be describe as the flow passing through the arcs of the second stage. The flow may describe the number of time slots 110 allocated to each mobile station 206, 208, 210 on the logical subchannels 102. Thus, it represents the solution vector X described in Eq. (2). Therefore, the flow may describe the number of time slots 110 allocated to each mobile station 206, 208, 210 on every subchannel 102 and the type of modulation and coding rate to be used with each time slot 110. In one embodiment, the model 600 may not limit the modulation type or coding rate to an optimal choice for the current SNR experienced on the respective subchannel 102. In fact, the base station may use different modulation types or coding rates (on different time slots 110) to transmit to the same mobile station 206, 208, 210 on one subchannel 102. For example, Table 1 describes the total number of nodes N and the total number of arcs A for the model described in FIG. 6 and two alternative models, with Nₙᵣₜ denoting the total number of NRT mobile stations 206, 208, 210.

TABLE 1
Number of nodes and arcs in the generalized MCNF

| | N | A |
|---|---|---|
| Model of FIG. 6 | K + G + N + Nₙᵣₜ | K + G + GN + 2Nₙᵣₜ |
| Alternative A | K + N + Nₙᵣₜ | K + KN + 2Nₙᵣₜ |
| Alternative B | K + N | K + KN |

If the solution of the generalized MCNF problem is still feasible to (2a)-(2d) (i.e., the resulting power does not exceed the limit), then the solution may also be optimal for the relaxed problem (2a)-(2d), and the dual Simplex solution 510 may be omitted. Conversely, if it is determined 508 that the total power PX resulting from the solution of the generalized MCNF problem is larger than TP_{T}, then this solution may not feasible for the relaxed problem. Nevertheless, because an optimal solution may already be found for (2a)-(2c), this solution may still be feasible for the dual of the relaxed problem defined by (2a)-(2d). Hence, the dual Simplex method may be directly applied 510, starting with the solution found by the generalized MCNF problem.

Finally, a simple approximation 514 scheme may be applied. First, X_{g,n} may be rounded to the nearest integer. Next, if all constraints are satisfied, then the method 500 may end. The number of time slots 110 allocated to over-allocated NRT mobile stations 206, 208, 210 may be decreased if it is either determined 504 the total power is greater than the limit or it is determined 512 that the number of time slots 110 allocated exceeds T for any subchannel 102. Additionally, the scheduler may compensate the under-allocated mobile stations 206, 208, 210 by granting them time slots 110 from the over allocated ones. It should be noted that, because the maximum error from the rounding may not exceed one time slot 110, the iterative procedure in this step is typically not computationally complex. Also, since X_{g,n} is integral in [0,T], the rounding error may be much less than for its counterpart in the case of one time slot 110 per frame where the allocation variable is in [0,1].

Although the method described in FIG. 5 in accordance with the model 600 described in FIG. 6 may achieve an advantageous solution, it may be relatively complex, especially if the number of mobile stations 206, 208, 210 and subchannel 102s is large. This is mainly due to the application 510 of the dual simplex algorithm to re-distribute the time slots 110 between mobile stations 206, 208, 210 in case it is determined 508 that the total power violates the power limit. Alternative embodiments may achieve comparable performance, but at much lower complexity. For example, the alternative models described below may omit the dual simplex step 510 and at the same time have lower number of nodes and arcs than described in the generalized MCNF model 600. Thus, these embodiments may enable a system designer to balance a trade-off between system performance and complexity.

### Alternative Model A

Certain previous methods assume that the total power is evenly distributed over all subchannel 102s, such that the maximum allowed power per time slot 110 equals P_{T}/K. Furthermore, has been asserted that averaging the power over all subchannel 102s and using the best modulation/coding scheme for each mobile station 206, 208, 210 does not significantly degrade the system performance. Under this assumption, the scheduler only uses the best available modulation type and coding rate (dₘ) for each mobile station 206, 208, 210/subchannel 102 combination. Because the maximum power per time slot 110 is known, this modulation/coding combination can be looked up using Eq. (1) before the scheduler is invoked. Hence, the number of data units that can be transmitted to the n^{th} mobile station 206, 208, 210 in one time slot 110 on the k^{th} subchannel 102, S_{k,n}=dₘ/β and the power needed to transmit this time slot 110 is P_{k,n}.

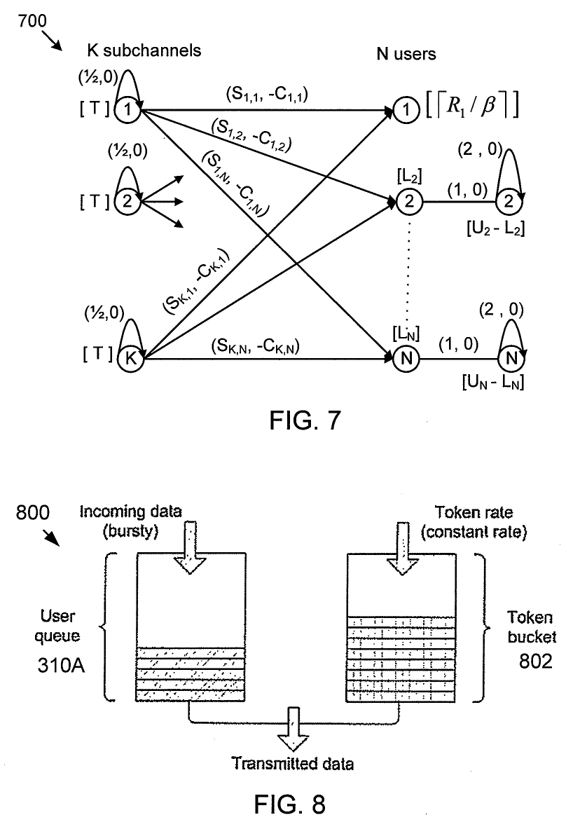

Under these assumptions, the generalized MCNF model 600 may be modified as shown in FIG. 7. Since only one modulation/coding combination is used for each mobile station 206, 208, 210/subchannel 102, the logical subchannel 102 nodes may be eliminated and the nodes representing the physical subchannels may be directly connected to the mobile station 206, 208, 210 nodes. On the arcs 608 connecting the subchannel 102s and the mobile stations' 206, 208, 210 nodes, the gain may be set to S_{k,n} and the cost is −C_{k,n}=−S_{k,n}+γP_{k,n}.

Also, as the transmitted power per subchannel 102 may not exceed P_{T}/K. For example, the solution of the generalized MCNF 700 may always be below the power limit TP_{T}. Thus, the Dual Simplex step 510 (shown in FIG. 5) may be eliminated. Furthermore, as the number of nodes and arcs 608 in the MCNF model 700 is reduced, the complexity of alternative model A may be significantly less than the complexity of the model 600 described in FIG. 6.

Table 1 shows the total number of nodes N and the total number of arcs A for Alternative Model A.

### Alternative Model B

Alternative model B may include the same assumptions as alternative model A 700. Additionally, the time diversity may be disabled. In alternative model B, the mobile stations 206, 208, 210 may require a fixed number of bits per frame. Thus, similar to the RT mobile stations 206, 208, 210, each NRT mobile station 206, 208, 210 may be represented by a single node in the generalized MCNF model (not shown). The number of data units required by this node in each frame may be set to a constant equal to R̅ₙ̅W/β. In other words, the instantaneous data rate that may be required by the NRT mobile station 206, 208, 210 in every frame may be substantially equivalent to the average data rate given to the NRT mobile station 206, 208, 210 in both the MCNF model 600 and alternative model A (700). As the number of nodes and arcs 608 is reduced, compared to that of alternative model A (700) (since the NRT mobile stations 206, 208, 210 may be represented by only one node), the complexity of the overall method and model may reduced. Thus, the complexity of alternative model B may be less than that of alternative model A (700), which in turn is less than model 600.

Table 1 shows the total number of nodes N and the total number of arcs A for alternative model B.

Since alternative models A and B are based on graph theory, both methods based on both models may achieve an optimal solution, under their respective assumptions. Moreover, if it is assume that there is only one OFDM symbol in the DL sub-frame (T=1), then the generalized MCNF model, represented by alternative model B, reduces to the maximum bipartite matching problem, for which a Hungarian algorithm may be used.

Moreover, more sophisticated algorithms may be used to dynamically change the mobile stations' 206, 208, 210 requirements in order to control packet delays or any other service or system related performance measures. For example, a system designer may wish to decrease the fairness of a mobile station 206, 208, 210 with bad channel conditions or at the cell edge. This may be modeled by temporarily decreasing the requirements of the respective mobile stations 206, 208, 210, or by reducing the cost of the arcs connecting the mobile station's 206, 208, 210 nodes to the subchannel 102s nodes. In such embodiments, modeling the OFDMA scheduling problem as a generalized MCNF problem according to the methods 400, 500 and models 600, 700 may be used. This is because the left hand side of the constraints (2a)-(2c), which define the generalized MCNF model, may not be affected by changing either the cost function or the mobile stations' 206, 208, 210 requirements.

### Mobile WiMAX

The IEEE 802.16e specifications describe different OFDM subcarrier permutations across the channel bandwidth. Although there may be many permutation methods defined by the standard, these methods can be grouped into two categories: (1) distributed subcarrier permutation, and (2) adjacent subcarrier permutation.

The distributed subcarrier permutation may distribute adjacent OFDM subcarriers in a pseudo-random manner across the whole channel bandwidth. Data transmission may then be performed on logically adjacent, but physically distributed subcarriers. This permutation may eliminate frequency selectivity that may be seen by the mobile station 206, 208, 210. The mobile station 206, 208, 210 may experience approximately the same CSI on each of the subchannels 102. Methods such as Partial Usage of Subcarriers (PUSC) or Full Usage of Subcarriers (FUSC) fall under the distributed subcarrier permutation category.

On the other hand, the adjacent subcarrier permutation follows closely the OFDMA model described above. Since data transmission may be performed on physically adjacent OFDM subcarriers, each mobile station 206, 208, 210 may experience different CSI on different subchannel 102s. Adaptive modulation and coding (AMC) is one example of a permutation method for the adjacent subcarrier permutation category.

To achieve the maximum performance, the IEEE 802.16e allows the base station 202 to use more than one permutation method within the same DL subframe 104 but in different zones. FIG. 9 shows an example with the PUSC and AMC zones. The number of subchannel 102s is denoted K_{P} and K_{M} in the PUSC and AMC zones, respectively. It should be noted that the zone boundary separating the different zones is typically the same across all subchannels 102.

The present embodiments, may support both subcarrier permutation categories. For example, the scheduling method 500 for an adjacent subcarrier permutation zone may be the same as described in FIGS. 5 and 6. However, scheduling for distributed permutation zone may include certain modifications. For example, in a distributed permutation zone, each mobile station sees the whole available bandwidth as only one subchannel 102. Thus, from the scheduling point of view, only one physical subchannel exists (i.e K=1). However, the available number of OFDM symbols in this single subchannel 102 may be logically increased to KT instead of T. FIG. 10 shows alternative model A (also illustrated in FIG. 7) applied to a distributed permutation zone. The number of nodes and arcs 608 in this model 1000 may be reduced. Therefore, the complexity of the scheduling model 1000 and associated method 500 may be reduced when applied to a distributed permutation zone, compared to the adjacent permutation case.

As the DL subframe 104 generally includes more than on permutation zone, the base station 202 may invoke the scheduling method 400, 500 for each zone separately. Distributing the total number of OFDM symbols on different zones and assigning mobile stations 206, 208, 210 to the zones may also be accomplished. Likewise, the distributed subcarrier permutation may be used to transmit to higher mobility mobile stations 206, 208, 210 while the adjacent subcarrier permutation may be more beneficial for fixed or nomadic mobile stations 206, 208, 210.

### MIMO Capabilities

Multiple-Input Multiple-Output (MIMO) refers to wireless networks 200 having mobile stations 206, 208, 210 with more than one antenna. Additionally, the base station 202 may include more than one antenna. For the purposes of embodiments describing MIMO, it can be assumed that the base station is equipped with M_{T} antennas and the n^{th} mobile station has M_{R}_{ₙ} antennas. Using multiple antennas may enhance the system performance, mainly through two approaches: (1) spatial diversity, and (2) spatial multiplexing. In spatial diversity, the same data stream is transmitted on all transmitter antennas on the same frequency subchannel 102. This redundancy may improve the link budget by decreasing the small-scale fading effect. Hence, spatial diversity may enable the base station to use more efficient modulation and coding schemes, and the data rate may increased logarithmically as a function of the number of antennas.

Spatial multiplexing uses the multiple antennas at the transmitter side to transmit distinct data streams on different antennas. Thus, compared to spatial diversity, the data rate may be dramatically increased according to the number of antennas. In fact, if no correlation exists between the base station antennas and mobile stations' 206, 208, 210 antennas (uncorrelated scattering), the data rate of the link between the base station and the n^{th} mobile station 206, 208, 210 may increase linearly according to min{M_{T},M_{R}_{ₙ}}.

Moreover, the IEEE 802.16e standard allows two methods for spatial multiplexing: (1) vertical encoding, and (2) horizontal encoding. In vertical encoding, only one FEC block may be transmitted on all antennas. Thus, implicitly restricting the streams transmitted on different antennas to belong to the same mobile station 206, 208, 210. In horizontal encoding, different FEC blocks can be transmitted on different antennas, thus, transmission to different mobile stations 206, 208, 210 (in the same time slot 110) is allowed.

The methods 400, 500 described in FIGS. 4 and 5 may be readily extended to support spatial diversity. Referring to Eq. (1), it can be seen that spatial multiplexing may reduce the SNR required (SNRreq) to use a certain modulation/coding scheme on any mobile station 206, 208, 210/subchannel 102 link. In one embodiment, only P_{g,n} and the corresponding lookup tables are changed to support spatial diversity. Arc gain Sₘ in model 600 or S_{k,n} in alternative models A (700) and B may remain the same as describe above.

On the other hand, supporting spatial multiplexing may require certain modifications to the models 600, 700. However, restricting our analysis to only the vertical encoding method simplifies the required changes. Referring to FIG. 6, spatial multiplexing may increase the gain of the link between the base station 202 and the n^{th} mobile station 206, 208, 210 using the g^{th} logical subchannel 102 S′_{g,n} to S′_{g,n}=S_{g,n} min{M_{T},M_{R}_{ₙ}}, where S_{g,n} is the same gain in a SISO network. In one embodiment, this linear increase in the number of antennas involves an assumption that the channels between the base station and the mobile station antennas are uncorrelated. The base station 202 may estimate the correlation factors between the different spatial channels and update S′_{g,n} appropriately.

### Performance Simulation Results

In this section, the performance of a generic OFDMA system is shown. Aside from the simulation results shown in the accompanying paper (Appendix 3), the assumptions in the system parameters used in this section are taken from the WiMAX standard. In the simulations, 16 subchannel 102s are available in a cell with 400 m radius. The frame length is 5 msec with 30 time slots 110 in the DL subframe 104. The average required rates for HTTP and FTP mobile stations 206, 208, 210 are 256 kbps and 512 kbps, respectively. It is assumed that the number of mobile stations 206, 208, 210 is fixed for the whole simulation. Also, the number of HTTP and FTP mobile stations 206, 208, 210 is assumed to be the same.

Three cases are simulated: two cases represent the developed algorithms but with different token bucket sizes. The size of the token bucket is chosen such that the time needed to fill the bucket with the constant virtual token rate is 1 and 2 seconds in the first and second case, respectively. In both cases, the scheduler selects one or more of the available modulation/coding schemes to transmit to any mobile station 206, 208, 210 on any subchannel 102. The third case simulates the assumption that the total power is evenly allocated to all the subchannel 102s. For this latter case, only the best modulation/coding scheme is used on each physical subchannel. The base station determines this modulation/coding scheme based on the CSI of the subchannel 102 and the SNR required by the service class. In the proposed model, this corresponds to connecting every mobile station 206, 208, 210 to K logical subchannel 102s. Each logical subchannel 102 represents the best modulation/coding scheme that can be used on the corresponding physical subchannel.

FIGS. 9A and 9B show the average data rate allocated to every NRT mobile station 206, 208, 210 in the DL direction. FIGS. 9A and 9B show that limiting the available modulation/coding schemes to only the best available one (after evenly dividing the power over all subchannel 102s) degrades the performance. By using all of the available modulation/coding schemes, the base station 202 is able to distribute its power effectively (choose one or more modulation/coding schemes) to support the mobile stations 206, 208, 210 in a better way. In other words, the base station 202 is able to serve each mobile station 206, 208, 210 with a data rate closer to the required 256 kbps and 512 kbps for HTTP and FTP services, respectively. This is obvious by noting that while the average data rate seen by each mobile station 206, 208, 210 drops significantly for the constant power case, the drop is negligible by using the proposed algorithm.

For the present embodiments, it is interesting that the token bucket (TB) fill times of 1 and 2 seconds (cases 1 and 2) have approximately the same performance. It can be inferred that, in both cases, the TB size is very large and is never filled to its limit.

It should be emphasized that the performance of the constant power case shown assumes support of a time domain degree of freedom. As outlined in the background section above, mot of the prior known solutions do not support a time domain degree of freedom.

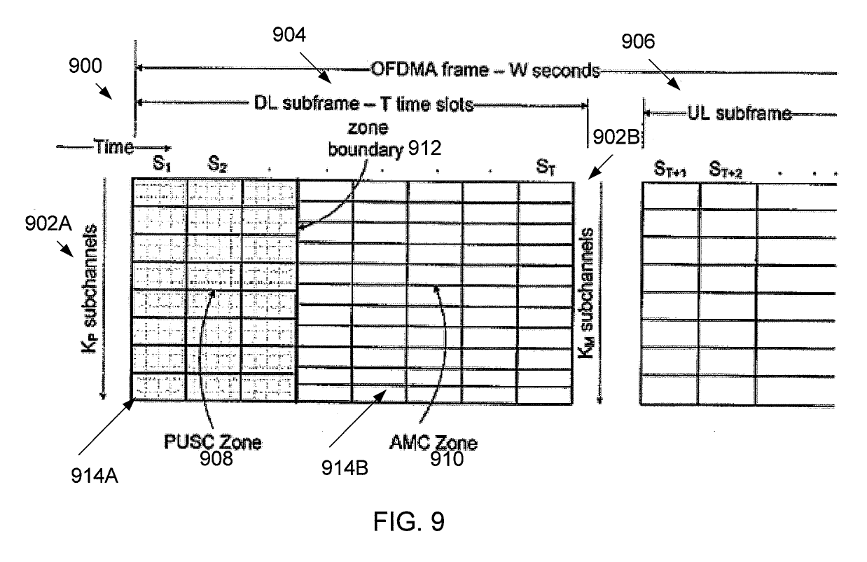

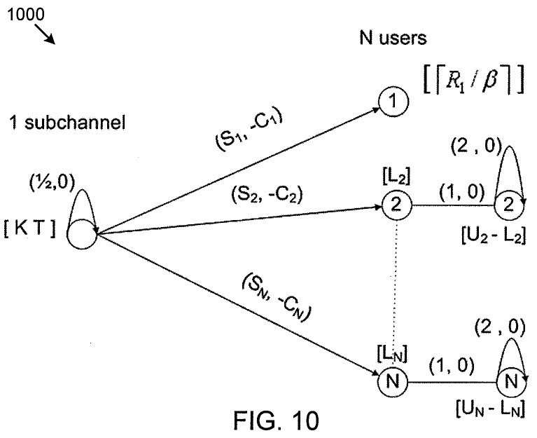

It is observed from FIG. 10 that the probability the scheduler 308 fails to solve the scheduling problem increases for the constant power case. Again, this is a consequence of limiting the available modulation/coding schemes to only the best one. Also, FIG. 11 shows the enhancement in the system utilization gained by using an embodiment of the proposed algorithm.

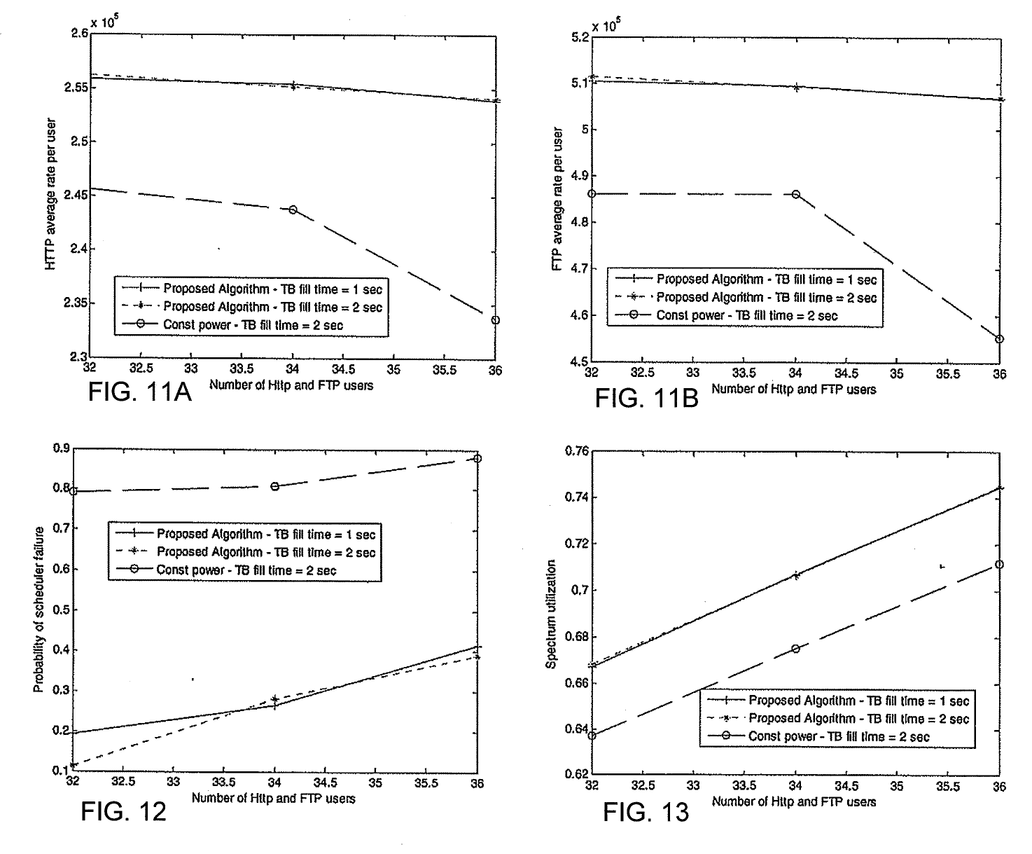

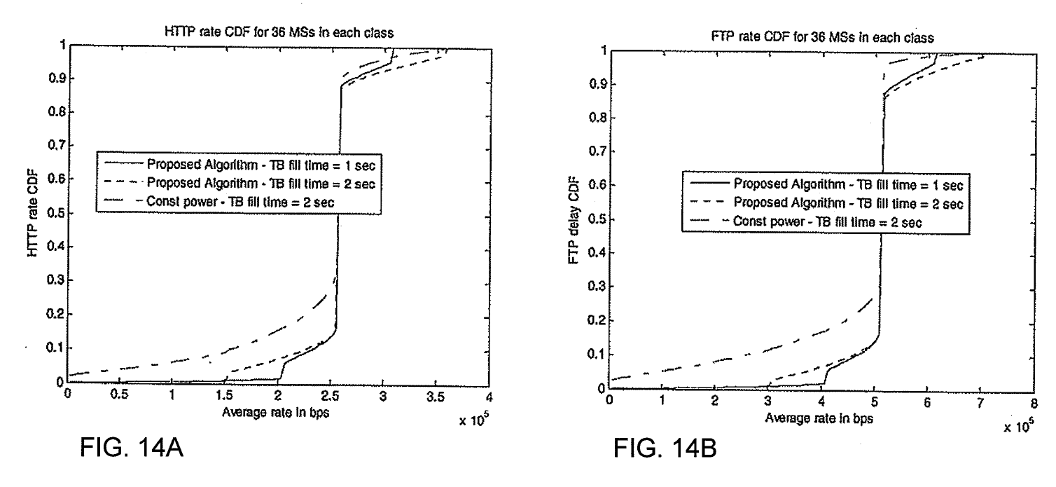

Finally, FIGS. 12A and 12B show the cumulative distribution function (CDF) for data rate achieved by both the HTTP and FTP mobile stations 206, 208, 210, assuming an averaging interval of 5 seconds. The tail before the threshold of 256 kbps and 512 kbps for HTTP and FTP mobile stations 206, 208, 210 shows that some mobile stations 206, 208, 210 are not given their required data rates. However, the heavy tail in the constant power allocation case means that the probability of this event is larger if the power is evenly distributed over all subchannel 102s. For example, by averaging the power evenly over all subchannel 102s, about 30% of the HTTP and FTP mobile stations 206, 208, 210 are given data rates lower than the threshold. On the other hand, in all cases, the data rates sometimes exceed the threshold of 256 kbps and 512 kbps for HTTP and FTP services, respectively. This is mainly due to the effect of the added time domain degree of freedom that enables the base station 202 to compensate some of the mobile stations 206, 208, 210 that are not given their required data rates at earlier times. Nevertheless, the present embodiments may enable the base station 202 to compensate these mobile stations 206, 208, 210 more effectively such that the overall data rates are closer to the rates required. The ability of the base station 202 to better compensate these mobile stations 206, 208, 210 can be proved from FIGS. 12A and 12B by noting that the area under the tail to the left of the threshold is approximately equal to the area over the curve to the right of it. This is also evident from FIGS. 9A and 9B which show that the overall data rates are approximately what is appropriate for each service.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for efficient Quality of Service (QoS) scheduling, the method comprising:
determining a number of time slots to allocate to one of a plurality of wireless mobile stations according to a linear solution that satisfies one or more data access requirements and maximizes base station utilization;
adjusting the linear solution in response to a determination that a power consumption value exceeds a predetermined threshold value; and
granting the one or more mobile stations access to the time slots in accordance with the linear solution.

2. The method of claim 1, wherein determining a number of time slots further comprises:
generating a generalized Minimum Cost Network Flow (MCNF) model of a scheduling problem; and
determining a solution to the generalized MCNF model.

3. The method of claim 2, further comprising dropping a mobile station in response to a determination that the solution to the generalized MCNF model is not feasible.

4. The method of claim 2, further comprising determining a dual simplex solution to the generalized MCNF model according to a dual simplex process in response to a determination that the solution to the generalized MCNF model results in a power consumption level that is greater than a predetermined power consumption threshold.

5. The method of claim 4, further comprising dropping a mobile station in response to a determination that the dual simplex solution to the generalized MCNF model is not feasible.

6. The method of claim 1, further comprising approximating the linear solution according to a rounded integer solution.

7. The method of claim 1, comprising maintaining a token bucket for each of a plurality of non-real-time mobile stations and determining whether to allocate a time slot to one or more of the plurality of non-real-time mobile stations in accordance with a size of the token bucket associated with the mobile station.

8. The method of claim 1, wherein determining the number of time slots to allocate further comprises:
dividing the time slots into a first zone and a second zone;
generating a respective generalized Minimum Cost Network Flow (MCNF) model of a scheduling problem for each of the first zone and the second zone according to a zone type associated with the first zone and the second zone; and
calculating a linear solution that satisfies one or more data access requirements and maximizes base station utilization for each zone respectively.

9. The method of claim 1, further comprising:
determining a number of time slots to allocate to one of a plurality of communication mobile stations, each mobile station having one or more antennas according to a linear solution that satisfied one or more data access requirements and maximizes base station utilization;
adjusting the linear solution, for each of the one or more antennas respectively, in response to a determination that a power consumption value exceeds a predetermined threshold value for the respective antenna; and
granting the one or more antennas associated with the mobile stations access to the time slots in accordance with the linear solution.

10. A multi-carrier wireless communication system comprising:
one or more wireless mobile stations configured to communicate information according to one or more predetermined communication configurations; and
a base station configured to:
determine a number of time slots to allocate to one of the mobile stations according to a linear solution that satisfies one or more data access requirements and maximizes base station utilization;
adjust the linear solution in response to a determination that a power consumption value exceeds a predetermined threshold value; and
grant the one or more mobile stations access to the time slots in accordance with the linear solution.

11. The multi-carrier wireless communication system of claim 10, wherein the base station is further configured to:
generate a generalized Minimum Cost Network Flow (MCNF) model of a scheduling problem; and
determine a solution to the generalized MCNF model.

12. The multi-carrier wireless communication system of claim 11, wherein the base station is further configured to drop a mobile station in response to a determination that the solution to the generalized MCNF model is not feasible.

13. The multi-carrier wireless communication system of claim 11, wherein the base station is further configured to determine a dual simplex solution to the generalized MCNF model according to a dual simplex process in response to a determination that the solution to the generalized MCNF model results in a power consumption level that is greater than a predetermined power consumption threshold.

14. The multi-carrier wireless communication system of claim 13, wherein the base station is further configured to drop a mobile station in response to a determination that the dual simplex solution to the generalized MCNF model is not feasible.

15. A computer readable medium comprising computer readable instructions that, when executed by a computer, cause the computer to the perform operations comprising:
determining a number of time slots to allocate to one of a plurality of wireless mobile stations according to a linear solution that satisfies one or more data access requirements and maximizes base station utilization;
adjusting the linear solution in response to a determination that a power consumption value exceeds a predetermined threshold value; and
granting the one or more mobile stations access to the time slots in accordance with the linear solution.

16. The computer readable medium of claim 15, wherein determining a number of time slots further comprises:
generating a generalized Minimum Cost Network Flow (MCNF) model of a scheduling problem; and
determining a solution to the generalized MCNF model.

17. The computer readable medium of claim 16, further comprising dropping a mobile station in response to a determination that the solution to the generalized MCNF model is not feasible.

18. The computer readable medium of claim 16, further comprising determining a dual simplex solution to the generalized MCNF model according to a dual simplex process in response to a determination that the solution to the generalized MCNF model results in a power consumption level that is greater than a predetermined power consumption threshold.

19. The computer readable medium of claim 18, further comprising dropping a mobile station in response to a determination that the dual simplex solution to the generalized MCNF model is not feasible.

20. The computer readable medium of claim 15, wherein determining the number of time slots to allocate further comprises:
dividing the time slots into a first zone and a second zone;
generating a respective generalized Minimum Cost Network Flow (MCNF) model of a scheduling problem for each of the first zone and the second zone according to a zone type associated with the first zone and the second zone; and
calculating a linear solution that satisfies one or more data access requirements and maximizes base station utilization for each zone respectively.
